(19) United States
(12) Patent Application Publication
(10) Pub. No.: US 2024/0319325 A1
(43) Pub. Date: Sep. 26, 2024

(54) Mitigating Radar-to-Radar Jamming Within a Shareable Time Slot

(71) Applicant: Qualcomm Incorporated, San Diego, CA (US)

(72) Inventors: Ahmad Bassil Zoubi, San Diego, CA (US); Roberto Rimini, San Diego, CA (US); Sheng-Yuan Tu, San Diego, CA (US)

(21) Appl. No.: 18/125,571

(22) Filed: Mar. 23, 2023

(51) Int. Cl. G01S 7/02; G01S 7/00; G01S 7/35; G01S 13/04; H04W 72/0446

(52) U.S. Cl. CPC G01S 7/0235; G01S 7/006; G01S 7/354; G01S 13/04; H04W 72/0446

(57) ABSTRACT

An apparatus for is disclosed for mitigating radar-to-radar jamming within a shareable time slot. The apparatus includes a wireless transceiver configured to transmit a first radar signal during a first shareable time slot. The first radar signal has a start time that is delayed relative to a start time of the first shareable time slot by a first time delay. Additionally, the wireless transceiver is configured to receive a first receive signal during the first shareable time slot and detect a potential object based on the first receive signal. Furthermore, the wireless transceiver is configured to transmit, using the first antenna, a second radar signal during a second shareable time slot. The second radar signal has a start time that is delayed relative to a start time of the second shareable time slot by a second time delay. The second time delay is different than the first time delay based on the detection of the potential object.

### TECHNICAL FIELD

This disclosure relates generally to wireless transceivers and, more specifically, to mitigating radar-to-radar jamming within a shareable time slot.

### BACKGROUND

To increase transmission rates and throughput, cellular and other wireless networks are using signals with higher frequencies and smaller wavelengths. As an example, 5th generation (5G)-capable devices communicate with networks using frequencies that include those at or near the extremely-high frequency (EHF) spectrum (e.g., frequencies greater than 25 gigahertz (GHz)) with wavelengths at or near millimeter wavelengths. These signals have various technological challenges, such as higher path loss as compared to signals for earlier generations of wireless communications. In certain scenarios it can be difficult for a 5G wireless signal to travel far enough to make cellular communications feasible at these higher frequencies.

Transmit power levels can be increased or beamforming can concentrate energy in a particular direction to compensate for the higher path loss. These types of compensation techniques, however, increase power densities. The Federal Communications Commission (FCC) has determined a maximum permitted exposure (MPE) limit to accommodate these higher power densities. To meet targeted guidelines based on this MPE limit, devices balance performance with transmission power and other considerations. This balancing act can be challenging to realize given cost, size, functional design objectives and/or involved constraints.

### SUMMARY

An apparatus is disclosed that mitigates radar-to-radar jamming within a shareable time slot. In example implementations, a computing device employs proximity detection during a shareable time slot, such as an uplink random-access-channel time slot, and adjusts transmission parameters for wireless communication based on whether or not an object is detected. Other computing devices can also perform proximity detection, which can cause a signal collision during the shareable time slot. In particular, the computing device can receive, during the shareable time slot, a radar signal that is transmitted by another computing device in addition to or instead of a reflected version of a radar signal that it transmitted. This interfering radar signal can cause the computing device to generate a false detection. To avoid persistent false detections, the computing device adjusts a time delay for transmitting a subsequent radar signal within a subsequent shareable time slot. The adjustment to the time delay is sufficient to cause the interference generated by the other computing device to be filtered during the subsequent shareable time slot. Using these techniques, multiple computing devices can perform proximity detection while appreciably reducing a probability of signal collisions causing radar-to-radar jamming.

In an example aspect, an apparatus is disclosed. The apparatus includes a wireless transceiver configured to be coupled to at least two antennas. The wireless transceiver is also configured to transmit, using a first antenna of the at least two antennas, a first radar signal during a first shareable time slot. The first radar signal has a start time that is delayed relative to a start time of the first shareable time slot by a first time delay. Additionally, the wireless transceiver is configured to receive, using a second antenna of the at least two antennas, a first receive signal during the first shareable time slot and detect a potential object based on the first receive signal. Furthermore, the wireless transceiver is configured to transmit, using the first antenna, a second radar signal during a second shareable time slot. The second radar signal has a start time that is delayed relative to a start time of the second shareable time slot by a second time delay. The second time delay is different than the first time delay based on the detection of the potential object.

In an example aspect, a method for mitigating radar-to-radar jamming within a shareable time slot is disclosed. The method includes transmitting a first radar signal during a first shareable time slot. The first radar signal has a first time delay defined relative to a start time of the first shareable time slot. The method also includes receiving a first receive signal during the first shareable time slot. The method additionally includes determining that a potential object is present based on the first receive signal. The method further includes adjusting, based on the determination that the potential object is present, a second time delay of a second radar signal associated with a subsequent shareable time slot to cause the second time delay to differ from the first time delay.

In an example aspect, an apparatus is disclosed. The apparatus includes means for transmitting multiple radar signals during multiple shareable time slots. The multiple radar signals have respective time delays defined relative to start times of the multiple shareable time slots. The apparatus also includes means for receiving multiple receive signals during the multiple shareable time slots. The apparatus additionally includes means for determining, for at least one shareable time slot of the multiple shareable time slots, that a potential object is present based on a corresponding receive signal of the multiple receive signals. The apparatus further includes means for adjusting, based on the determination for the at least one shareable time slot that the potential object is present, a time delay of a radar signal associated with a subsequent shareable time slot to cause the time delay to differ from a time delay associated with the at least one shareable time slot.

In an example aspect, a method for mitigating radar-to-radar jamming within a shareable time slot is disclosed. The method includes transmitting a first radar signal during a first shareable time slot based on a first time delay relative to a start time of the first shareable time slot. The method also includes transmitting a second radar signal during a second shareable time slot based on a second time delay relative to a start time of the second shareable time slot. The second time delay is selectively adjusted to be different than or similar to the first time delay.

### BRIEF DESCRIPTION OF DRAWINGS

FIG. 1 illustrates an example operating environment for mitigating radar-to-radar jamming within a shareable time slot.

FIG. 2 illustrates an example operating environment for proximity detection that includes mitigating radar-to-radar jamming within a shareable time slot.

FIG. 3 illustrates an example sequence flow diagram for proximity detection and wireless communication.

FIG. 4 illustrates example components of a wireless transceiver for mitigating radar-to-radar jamming within a shareable time slot.

FIG. 5 illustrates example components of a transmitter, a receiver, and a modem for mitigating radar-to-radar jamming within a shareable time slot.

FIG. 6 illustrates an example local oscillator circuit for supporting proximity detection and wireless communication.

FIG. 7 illustrates an example shareable time slot.

FIG. 8 illustrates examples of radar-to-radar jamming within a shareable time slot.

FIG. 9 illustrates an example scheme for mitigating radar-to-radar jamming within a shareable time slot.

FIG. 10 is a flow diagram illustrating an example process for mitigating radar-to-radar jamming within a shareable time slot.

FIG. 11 is another flow diagram illustrating an example process for mitigating radar-to-radar jamming within a shareable time slot.

### DETAILED DESCRIPTION

Current high-frequency and small-wavelength communications balance performance with a need to meet the Federal Communications Commission's maximum permitted exposure limit (e.g., the FCC's MPE limit). Inefficient balancing can prevent devices from taking full advantage of increased data rates (e.g., those enabled by 5G wireless communications). Because exposure is affected by the proximity of a user to a device's antenna, however, techniques described in this document enable greater wireless performance while staying within the FCC's MPE limit. To do so, these techniques detect a user's proximity to a device. Based on the detected proximity, the device can balance a power density of transmitted wireless signals with the requirement to meet the MPE limit. As a result, the device is permitted to transmit wireless signals with higher average power levels, which enables the wireless signals to travel farther, such as between a smart phone and a remote cellular base station. Devices and techniques described herein may additionally or alternatively be used to comply with radio frequency exposure requirements promulgated by an organization or jurisdiction outside of the United States.

Some proximity-detection techniques may use a dedicated sensor to detect the user, such as a camera or an infrared sensor. However, these sensors may be bulky or expensive. Furthermore, a single electronic device can include multiple antennas that are positioned on different surfaces (e.g., on a top, a bottom, or opposite sides). To account for each of these antennas, multiple cameras or sensors may need to be installed near each of these antennas, which further increases a cost and size of the electronic device.

In contrast, techniques for proximity detection with mitigating radar-to-radar jamming within a shareable time slot are described herein. In example implementations, a computing device employs proximity detection during a shareable time slot, such as an uplink random-access-channel time slot, and adjusts transmission parameters for wireless communication based on whether or not an object is detected. The described techniques utilize a wireless transceiver and antennas within a computing device to perform proximity detection during the shareable time slot. With proximity detection, a transmission parameter that is used for wireless communication can be adjusted based on whether or not an object is detected. This adjustment enables the wireless transceiver to meet guidelines promulgated by the government or the wireless industry, such as a Maximum Permitted Exposure (MPE) limit as determined by the Federal Communications Commission (FCC). Additionally, devices and techniques described herein may additionally or alternatively be used for or modified for purposes other than exposure compliance, for example to detect objects other than a user, to map an environment, for other forms of radio frequency (RF) or millimeter-wave sensing, for sensor assisted communication or joint communicating and sensing, etc.

A shareable time slot represents a time slot in which two or more devices can perform aspects of proximity detection, which at least includes transmitting a radar signal. In some examples, the two or more devices are also in communication with a same network. In some further examples, time slots which are shareable may be defined by the network or identifiable based on the network or communications therewith. With multiple devices transmitting radar signals, a signal collision can occur causing radar-to-radar jamming during the shareable time slot. For instance, the computing device can receive, during the shareable time slot, a radar signal that is transmitted by another computing device in addition to or instead of a reflected version of a radar signal that it transmitted. This interfering radar signal can cause the computing device to generate a false detection. To avoid persistent false detections, the computing device adjusts a time delay for transmitting a subsequent radar signal within a subsequent shareable time slot. The adjustment to the time delay is sufficient to cause the interference generated by the other computing device to be filtered during the subsequent shareable time slot. Using these techniques, multiple computing devices can perform proximity detection while appreciably reducing a probability of signal collisions causing radar-to-radar jamming.

Some embodiments may offer a relatively inexpensive approach that can utilize existing transceiver hardware and antennas. For instance, the computing device can selectively perform proximity detection or wireless communication. In such cases, dual-use of components within the wireless transceiver of a computing device may be enabled, which decreases cost and size of the wireless transceiver, as well as the computing device. In other implementations, the computing device may be utilized in stand-alone proximity-detection applications. For example, the computing device can be implemented as an automotive bumper sensor to assist with parking or autonomous driving. As another example, the computing device can be installed on a drone to provide collision avoidance. Based on the proximity detection, and as described herein, transmission parameters can be adjusted for wireless communication to enable the wireless transceiver to meet safety guidelines promulgated by the government or the wireless industry, such as a Maximum Permitted Exposure (MPE) limit as determined by the Federal Communications Commission (FCC).

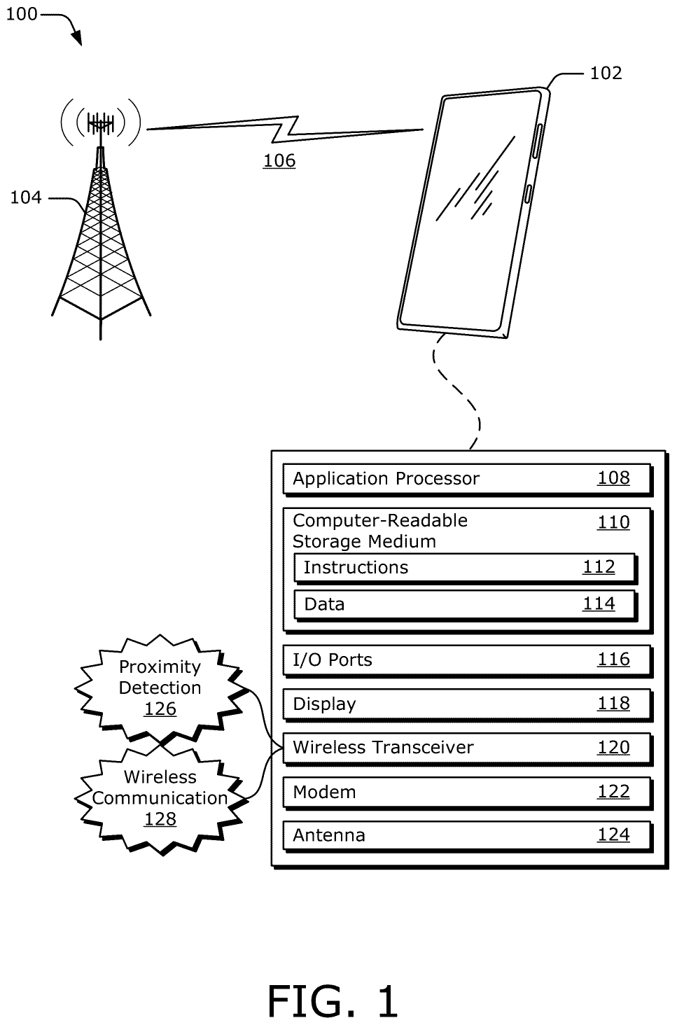

FIG. 1 illustrates an example environment 100 for mitigating radar-to-radar jamming within a shareable time slot. In the environment 100, a computing device 102 communicates with a base station 104 through a wireless communication link 106 (wireless link 106). In this example, the computing device 102 is depicted as a smartphone. However, the computing device 102 can be implemented as any suitable computing or electronic device, such as a modem, a cellular base station, a broadband router, an access point, a cellular phone, customer premises equipment (CPE), a gaming device, a navigation device, a media device, a laptop computer, a desktop computer, a tablet computer, a wearable computer, a server, a network-attached storage (NAS) device, a smart appliance or other internet of things (IoT) device, a medical device, a vehicle-based communication system, a radar, a radio apparatus, and so forth.

The base station 104 communicates with the computing device 102 via the wireless link 106, which can be implemented as any suitable type of wireless link. Although depicted as a tower of a cellular network, the base station 104 can represent or be implemented as another device, such as a satellite, a server device, a terrestrial television broadcast tower, an access point, a peer-to-peer device, another smartphone, a mesh network node, and so forth. Therefore, the computing device 102 may communicate with the base station 104 or another device via a wireless connection.

The wireless link 106 can include a downlink of data or control information communicated from the base station 104 to the computing device 102, an uplink of other data or control information communicated from the computing device 102 to the base station 104, or both a downlink and an uplink. The wireless link 106 can be implemented using any suitable communication protocol or standard, such as 2nd-generation (2G), 3rd-generation (3G), 4th-generation (4G), or 5th-generation (5G) cellular: IEEE 802.11 (e.g., Wi-Fi®): IEEE 802.15 (e.g., Bluetooth® or ultra-wideband (UWB)): IEEE 802.16 (e.g., WiMAX®); and so forth. In some implementations, the wireless link 106 may wirelessly provide power and the base station 104 or the computing device 102 may comprise a power source.

As shown, the computing device 102 includes an application processor 108 and a computer-readable storage medium 110 (CRM 110). The application processor 108 can include any type of processor, such as a multi-core processor, that executes processor-executable code stored by the CRM 110. The CRM 110 can include any suitable type of data storage media, such as volatile memory (e.g., random access memory (RAM)), non-volatile memory (e.g., Flash memory), optical media, magnetic media (e.g., disk), and so forth. In the context of this disclosure, the CRM 110 is implemented to store instructions 112, data 114, and other information of the computing device 102, and thus does not include transitory propagating signals or carrier waves.

The computing device 102 can also include input/output ports 116 (I/O ports 116) and a display 118. The I/O ports 116 enable data exchanges or interaction with other devices, networks, or users. The I/O ports 116 can include serial ports (e.g., universal serial bus (USB) ports), parallel ports, audio ports, infrared (IR) ports, user interface ports such as a sensing portion of a touchscreen, and so forth. The display 118 presents graphics of the computing device 102, such as a user interface associated with an operating system, program, or application. Alternatively or additionally, the display 118 can be implemented as a display port or virtual interface, through which graphical content of the computing device 102 is presented, and/or the display 118 can be omitted.

A wireless transceiver 120 of the computing device 102 provides connectivity to respective networks and other electronic devices connected therewith. The wireless transceiver 120 can facilitate communication over any suitable type of wireless network, such as a wireless local area network (WLAN), peer-to-peer (P2P) network, mesh network, cellular network, ultra-wideband network, wireless wide-area-network (WWAN), and/or wireless personal-area-network (WPAN). In the context of the example environment 100, the wireless transceiver 120 enables the computing device 102 to communicate with the base station 104 and networks connected therewith. However, the wireless transceiver 120 can also enable the computing device 102 to communicate “directly” with other devices or networks.

The wireless transceiver 120 includes circuitry and logic for transmitting and receiving signals via an antenna 124. Components of the wireless transceiver 120 can include amplifiers, switches, mixers, analog-to-digital converters, filters, and so forth for conditioning signals (e.g., for generating or processing signals). The wireless transceiver 120 can also include logic to perform in-phase/quadrature (I/Q) operations, such as synthesis, encoding, modulation, decoding, demodulation, and so forth. In some cases, components of the wireless transceiver 120 are implemented as separate transmitter and receiver entities. Additionally or alternatively, the wireless transceiver 120 can be realized using multiple or different sections to implement respective transmitting and receiving operations (e.g., separate transmit and receive chains). In general, the wireless transceiver 120 processes data and/or signals associated with communicating data of the computing device 102 over the antenna 124 and/or processes signals associated with proximity detection.

In the example shown in FIG. 1, the computing device 102 includes at least one modem 122. The modem 122, which can be implemented as a processor, controls the wireless transceiver 120 and enables proximity detection 126 or wireless communication 128 to be performed. The modem 122 can include a portion of the CRM 110 or can access the CRM 110 to obtain computer-readable instructions. The modem 122 can include baseband circuitry to perform high rate sampling processes that can include analog-to-digital conversion, digital-to-analog conversion, Fourier transforms, gain correction, skew correction, frequency translation, and so forth. The modem 122 can provide communication data to the wireless transceiver 120 for transmission. The modem 122 can also process a baseband version of a signal obtained from the wireless transceiver 120 to generate data, which can be provided to other parts of the computing device 102 via a communication interface for proximity detection 126 or wireless communication 128.

The modem 122 is coupled to the wireless transceiver 120 and can control timing within the wireless transceiver 120 to mitigate radar-to-radar jamming within a shareable time slot. To do this, the modem 122 implements a scheme that can selectively adjust (e.g., randomize) a time delay associated with transmitting a radar signal within a shareable time slot, as further described below.

The computing device 102 can also include a controller (not separately shown) to implement one or more aspects of mitigating radar-to-radar jamming within a shareable time slot. The controller can include at least one processor and CRM, which stores computer-executable instructions (such as the application processor 108, the CRM 110, and the instructions 112). The processor and the CRM can be localized at one module or one integrated circuit chip or can be distributed across multiple modules or chips. Together, a processor and associated instructions can be realized in separate circuitry, fixed logic circuitry, hard-coded logic, and so forth. The controller can be implemented as part of the wireless transceiver 120, the modem 122, the application processor 108, a special-purpose processor configured to perform MPE techniques, a general-purpose processor, some combination thereof, and so forth.

In an example implementation, the wireless transceiver 120 supports proximity detection 126 and wireless communication 128. In other words, the wireless transceiver 120 can be configured to perform proximity detection 126 during a first time interval and perform wireless communication 128 during a second time interval. In other example implementations, the wireless transceiver 120 supports proximity detection 126 and does not support wireless communication 128. In this case, the wireless transceiver 120 can be a transceiver of a dedicated radar system, which is integrated within the computing device 102 or a stand-alone radar system. In still other example implementations, the wireless transceiver 120 supports other applications, which can benefit from aspects of mitigating radar-to-radar jamming within a shareable time slot. In other examples, separate transceivers are respectively configured for proximity detection 126 and wireless communication 128.

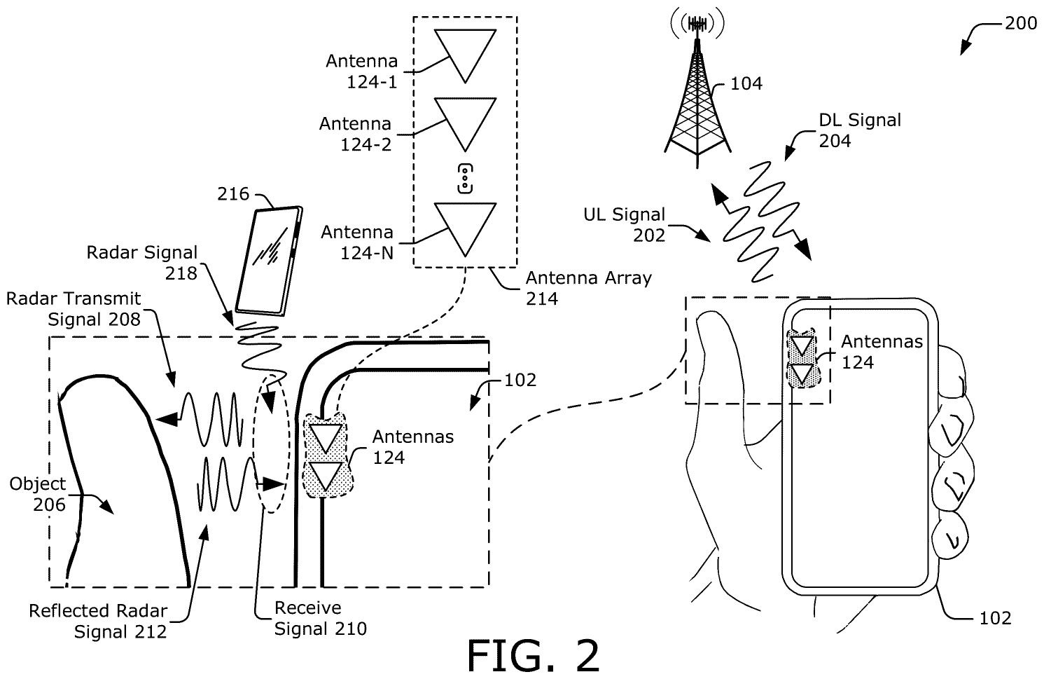

FIG. 2 illustrates an example operating environment 200 for proximity detection 126 and wireless communication 128. In the example environment 200, a user holds the computing device 102. In one aspect, the computing device 102 communicates with the base station 104 by transmitting an uplink signal 202 (UL signal 202) or receiving a downlink signal 204 (DL signal 204) via one or more antennas 124. A user's thumb, however, can represent a proximate object 206 that may be exposed to radiation via the uplink signal 202. Other situations are also possible in which the user (or a portion of the user) represents the proximate object 206, including those in which the user is near the computing device 102 but not physically touching the computing device 102. In an example situation, the computing device 102 is positioned within arm's reach of the user on a desk. As another example situation, the computing device 102 is propped up on a table and the user is watching a video on the computing device 102 from a distance.

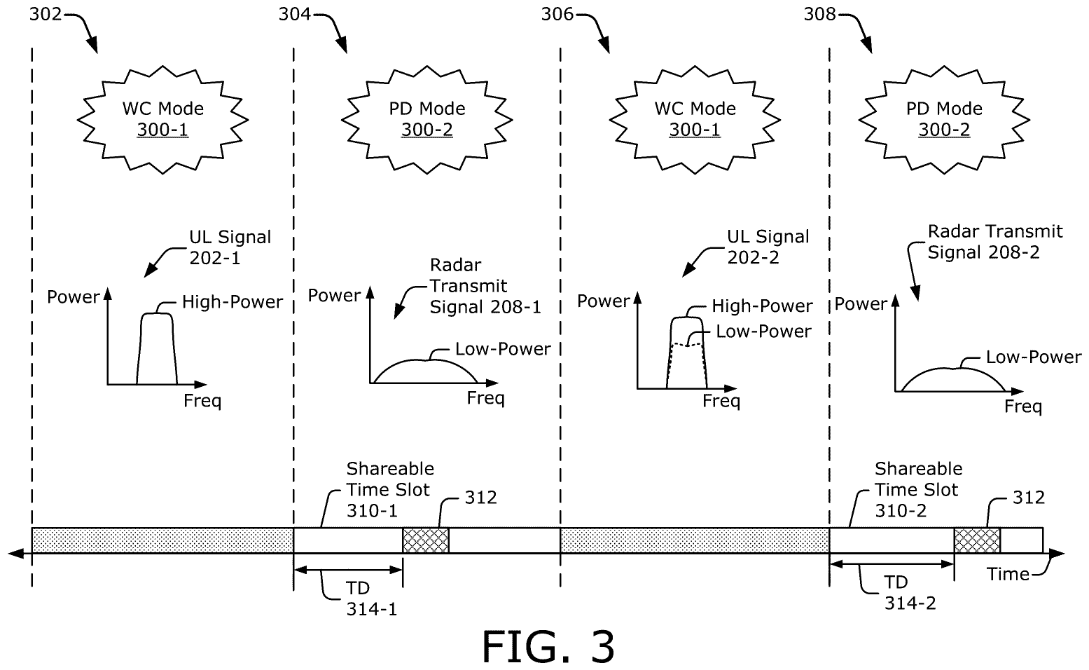

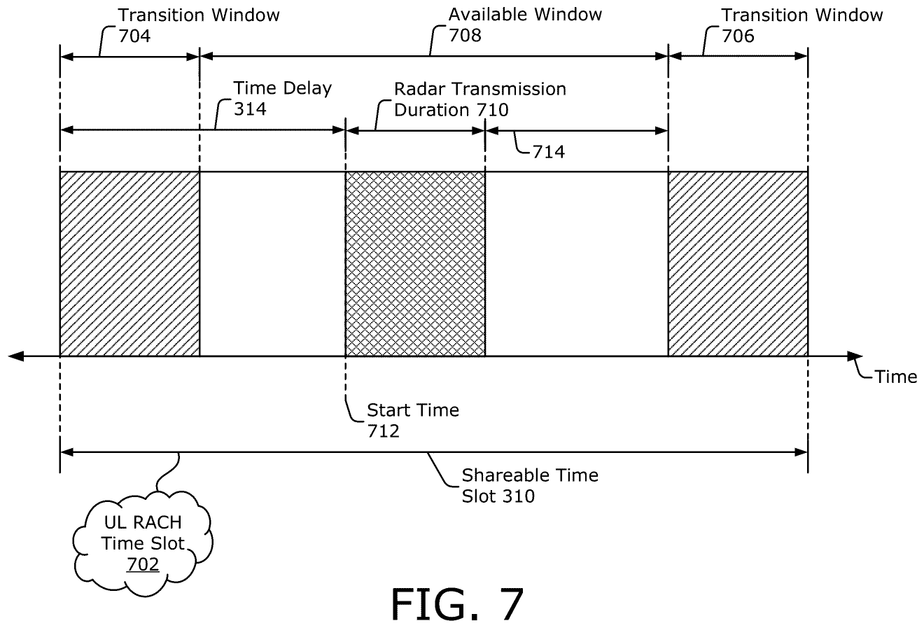

To detect whether the object 206 exists or is within a detectable range, the computing device 102 transmits a radar transmit signal 208 via at least one of the antennas 124 and receives a receive signal 210 via at least another one of the antennas 124. In general, the term “range” refers to a slant range or a distance. The transmission of the radar transmit signal 208 and the reception of the receive signal 210 occur during a portion of a shareable time slot, which is further described with respect to FIGS. 3 and 7. In some cases, the receive signal 210 can be received during a portion of time that the radar transmit signal 208 is transmitted. The receive signal 210 can include a reflected radar signal 212, which represents a version of the radar transmit signal 208 that is reflected by the object 206.

The radar transmit signal 208 can be implemented as a frequency-modulated continuous-wave (FMCW) signal or a frequency-modulated pulsed signal. The type of frequency modulation can include a linear frequency modulation, a triangular frequency modulation, a sawtooth frequency modulation, and so forth. Based on the reflected radar signal 212, the range to the object 206 can be determined. The same antennas 124 or a subset of the same antennas 124 used to communicate with the base station 104 can be used for proximity detection 126. In other examples, one or more of the antennas 124 used for proximity detection 126 are not used for wireless communication 128.

The antennas 124 may be arranged via modules and may have a variety of configurations. For example, the antennas 124 may comprise at least two different antennas, at least two antenna elements of an antenna array 214 (as shown towards the top of FIG. 2), at least two antenna elements associated with different antenna arrays, or any combination thereof. The antenna array 214 is shown to include multiple antennas 124-1 to 124-N, where N represents a positive integer greater than one. Further, the array 214 may be a multi-dimensional array. Consider, for example, the antennas 124 as comprising the first antenna 124-1 and the second antenna 124-2 of the antenna array 214. The first antenna 124-1 transmits the radar transmit signal 208, and the second antenna 124-2 receives the receive signal 210.

The antenna array 214 may be configured for beam management techniques, such as beam determination, beam measurement, beam reporting, or beam sweeping. A distance between the antennas 124 within the antenna array 214 can be based on frequencies that the wireless transceiver 120 emits. For example, the antennas 124 can be spaced apart by approximately half a wavelength from one another (e.g., by approximately half a centimeter (cm) apart for frequencies around 30 GHZ). The antennas 124 may be implemented using any type of antenna, including patch antennas, dipole antennas, bowtie antennas, or a combination thereof.

In some situations, another device 216 is proximate to the computing device 102 and performs proximity detection 126. For instance, the device 216 transmits a radar signal 218, which can be similar to the radar transmit signal 208. For example, the radar signal 218 can be a frequency-modulated continuous-wave signal or a frequency-modulated pulsed signal. Due to a proximity of the device 216 to the computing device 102 and/or a transmission time of the radar signal 218, the computing device 102 can receive at least a portion of the radar signal 218 during the shareable time slot as part of the receive signal 210. In this case, the radar signal 218 represents an interfering radar signal (e.g., a radar signal that causes radar-to-radar jamming within the computing device 102). In some situations, the computing device 102 can incorrectly identify the radar signal 218 as a reflection of the radar transmit signal 208 from an object-of-interest. This false detection can degrade a false-alarm-rate performance of the computing device 102.

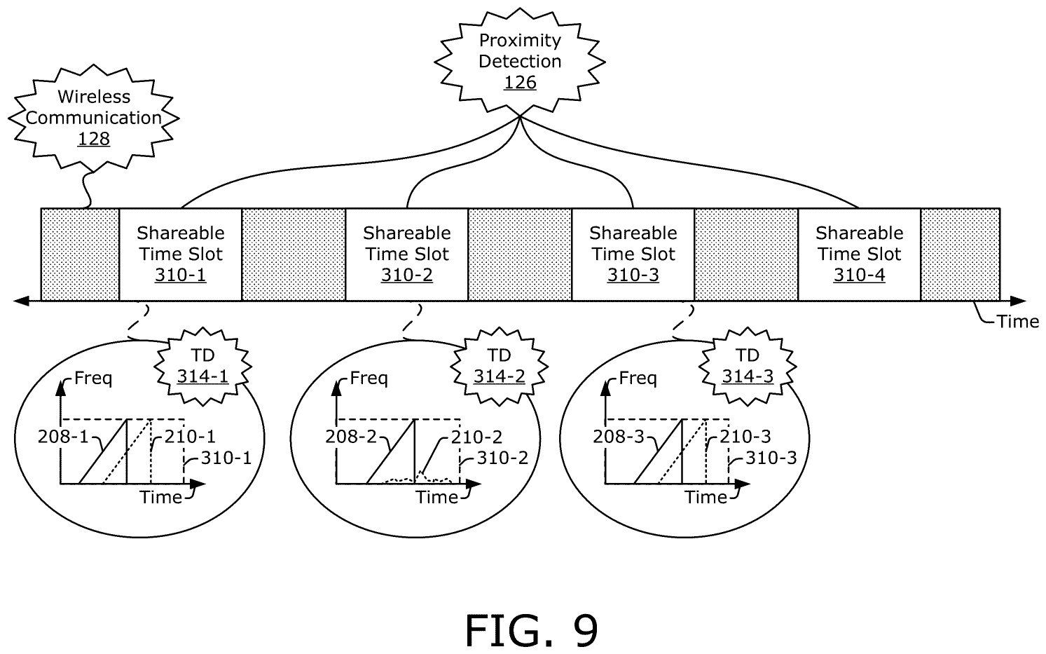

To decrease a probability of the device 216 contributing to future false detections, the computing device 102 employs techniques to mitigate radar-to-radar jamming within the shareable time slot by adjusting a time delay associated with transmission of the radar transmit signal 208 during a subsequent shareable time slot, as further described with respect to FIG. 9. By changing the time delay, the computing device 102 can shift a received version of the radar signal 218 (or additional radar signals from the computing device 216) in time or frequency to cause the radar signal 218 to be filtered (e.g., rejected or substantially attenuated). The adjustment to the time delay does not meaningfully impact an ability of the computing device 102 to detect the object 206. As such, the computing device 102 can continue to receive the reflected radar signal 212 and detect the object 206 independent of whether or not the time delay is adjusted.

At various times, the receive signal 210 can include the reflected radar signal 212, the radar signal 218, both the reflected radar signal 212 and the radar signal 218, or no radar signals (e.g., neither the reflected radar signal 212 nor the radar signal 218). The reflected radar signal 212 includes a portion of the radar transmit signal 208 that is reflected by the object 206. Based on the proximity detection 126, a transmission parameter can be adjusted for use during wireless communication 128. An example sequence for switching between proximity detection 126 and wireless communication 128 is further described with respect to FIG. 3.

FIG. 3 illustrates an example sequence flow diagram for proximity detection 126 and wireless communication 128, with time elapsing from left to right. Examples of a wireless communication mode 300-1 (WC mode 300-1) are shown at 302 and 306, and examples of a proximity detection mode 300-2 (PD mode 300-2) are shown at 304 and 308. The proximity detection mode 300-2 can occur during a shareable time slot 310, such as shareable time slot 310-1 at 304 and shareable time slot 310-2 at 308. The shareable time slot 310 can include a time interval in which proximity detection 126 is performed by two or more computing devices 102 (e.g., by the computing device 102 and the device 216). The shareable time slot 310 can occur at fixed time intervals, between active data cycles that occur during wireless communication 128, at predetermined times as set by the modem 122, as part of an initialization process before wireless communications 128 occur, and so forth. Additionally or alternatively, some implementations of the computing device 102 can perform proximity detection 126 responsive to detection of device movement, or based on indications that the user may be proximate to the computing device 102 (e.g., based on the wireless transceiver 120 observing a decrease in power in a downlink signal 204 or the application processor 108 determining that the user is interacting with the display 118 of the computing device 102).

At 302, the wireless transceiver 120 transmits a high-power (e.g., normal) uplink signal 202-1 configured to provide sufficient range to a destination, such as a base station 104. After transmitting the uplink signal 202-1, the computing device 102 transmits a radar transmit signal 208-1 during a first shareable time slot 310-1 at 304. A duration of a transmission of the radar transmit signal 208-1 within the first shareable time slot 310-1 is represented by a diamond pattern at 312. A start time of the radar transmit signal 208-1 is based on a time delay 314-1 (TD 314-1), which is relative to a start time of the first shareable time slot 310-1.

As described above, a radar transmit signal 208 enables the computing device 102 to detect an object 206 and determine if the object 206 is near the computing device 102. At 304, the radar transmit signal 208-1 is represented by a low-power wide-band signal. In example implementations, the radar transmit signal 208-1 can have a bandwidth of approximately 2 GHZ or more (e.g., 2 GHZ, 3 GHZ, 4 GHZ, and so forth). Based on a detection, the wireless transceiver 120 can adjust a transmission parameter for a next uplink signal 202 to account for MPE compliance guidelines.

In some examples, the proximity detection mode 300-2 can also determine the range to the object 206 thereby enabling transmission of the uplink signal 202 to comply with range-dependent guidelines, such as a maximum power density. Because power density is proportional to transmit power and inversely proportional to range, an object 206 at a closer range is exposed to a higher power density than another object 206 at a farther range for a same transmit power level. Therefore, a similar power density at the object 206 can be achieved by increasing the transmit power level if the object 206 is at a farther range and decreasing the transmit power level if the object 206 is at a closer range. In this way, the wireless transceiver 120 can adjust transmission of the uplink signal 202 to enable the power density at the object 206 for both the closer range and the farther range to be below the maximum power density. At the same time, because the range is known, the transmit power level can be increased to a level that facilitates wireless communication 128 and comports with the compliance guideline.

At 306, the wireless transceiver 120 transmits a next uplink signal 202-2. In the depicted example, the uplink signal 202-2 can be a high-power uplink signal if an object 206 is not detected at 304. Alternatively, the uplink signal 202-2 can be a low-power uplink signal if an object 206 is detected at 304. The low transmit power can be, for example, between approximately five and twenty decibel-milliwatts (dBm) less than the high-power signal at 302. In addition to or instead of changing a power, the uplink signal 202-2 can be transmitted using a different antenna within the computing device 102 or using a different beam steering angle (e.g., different than the antennas 124 or the beam steering angle used for transmitting the uplink signal 202-1 at 302). Although not shown, the wireless transceiver 120 can alternatively skip the wireless communication mode 300-1 at 306 and perform proximity detection 126 using another antenna or a different transmit power level to detect objects 206 at various locations or distances around the computing device 102. While certain operations were described above based on a range to the object 206, it will be appreciated that operations in the wireless communication mode 300-1 at 306 or adjustments made pursuant to the proximity detection mode 300-2 may be based merely upon whether the object 206 is present or not, irrespective of the range thereto.

At 308, the wireless transceiver 120 and antenna 124 transmit another radar transmit signal 208-2 during a second shareable time slot 310-2 to attempt to detect the object 206 (or another object). A second time delay 314-2 (TD 314-2) associated with the radar transmit signal 208-2 can be similar to or different than the first time delay 314-1 to mitigate radar-to-radar jamming, as further described with respect to FIG. 9. The wireless communication mode 300-1 and the proximity detection mode 300-2 are illustrated separately in FIG. 3 and do not overlap in some examples, but in other examples certain wireless communications may be transmitted during the proximity detection mode 300-2 or a portion thereof.

By scheduling multiple radar transmit signals 208 over some time period, transmission of the uplink signal 202 can be dynamically adjusted based on a changing environment or movement by the object 206. Furthermore, appropriate adjustments can be made to balance wireless communication performance with compliance or radiation requirements.

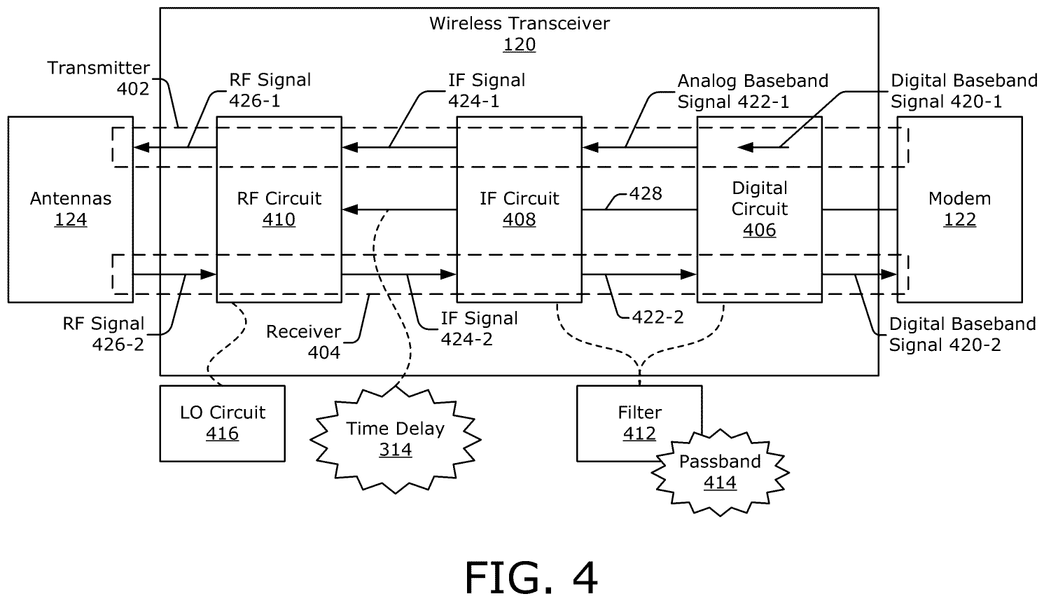

The sequence described above can also be applied to other antennas. The other antennas and the antennas 124 may transmit multiple radar transmit signals 208 sequentially or in parallel. To facilitate proximity detection 126 in the presence of radar-to-radar jamming within a shareable time slot 310, the modem 122 can control a timing of the transmission of the radar transmit signal 208, as further described with respect to FIG. 4.

FIG. 4 illustrates example components of the wireless transceiver 120. The wireless transceiver 120 is coupled between the antennas 124 and the modem 122, and includes a transmitter 402 and a receiver 404. In the depicted configuration, the wireless transceiver 120 also includes at least one digital circuit 406, at least intermediate-frequency (IF) circuit 408 (IF circuit 408), and at least one radio-frequency (RF) circuit 410 (RF circuit 410).

The transmitter 402 and the receiver 404 are distributed through portions of the digital circuit 406, the intermediate-frequency circuit 408, and the radio-frequency (RF) circuit 410. In general, the intermediate-frequency circuit 408 upconverts baseband signals to an intermediate frequency and downconverts intermediate-frequency signals to baseband. The intermediate frequency can be on the order of several gigahertz (GHZ), such as between approximately 5 and 15 GHZ. Likewise, the radio-frequency circuit 410 upconverts intermediate-frequency signals to radio frequencies and downconverts radio-frequency signals to intermediate frequencies. The radio frequencies can include frequencies in the extremely-high frequency (EHF) spectrum, such as frequencies between approximately 25 and 66 GHZ.

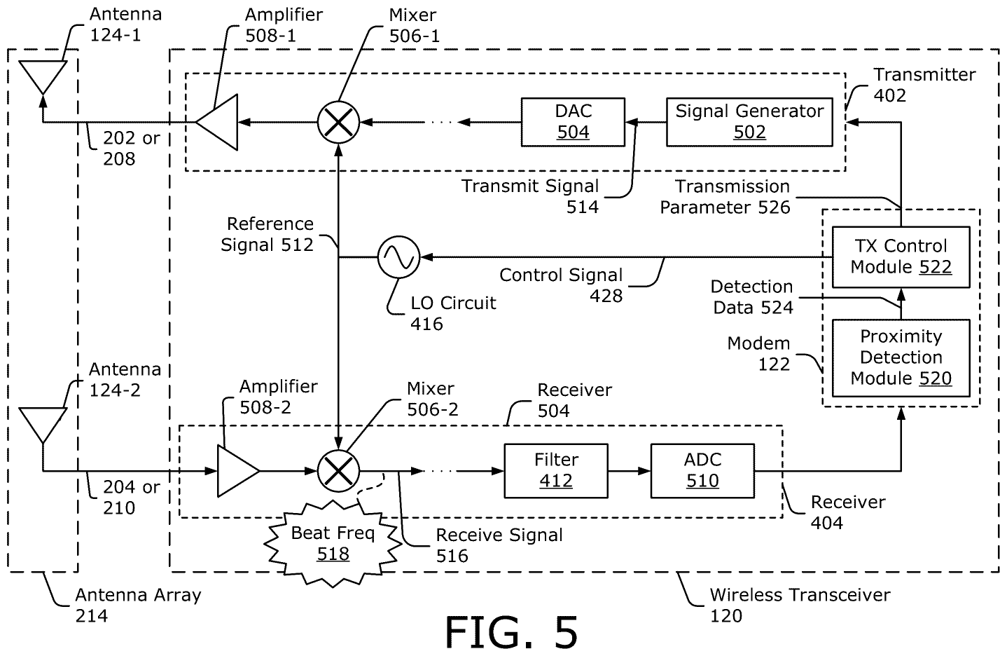

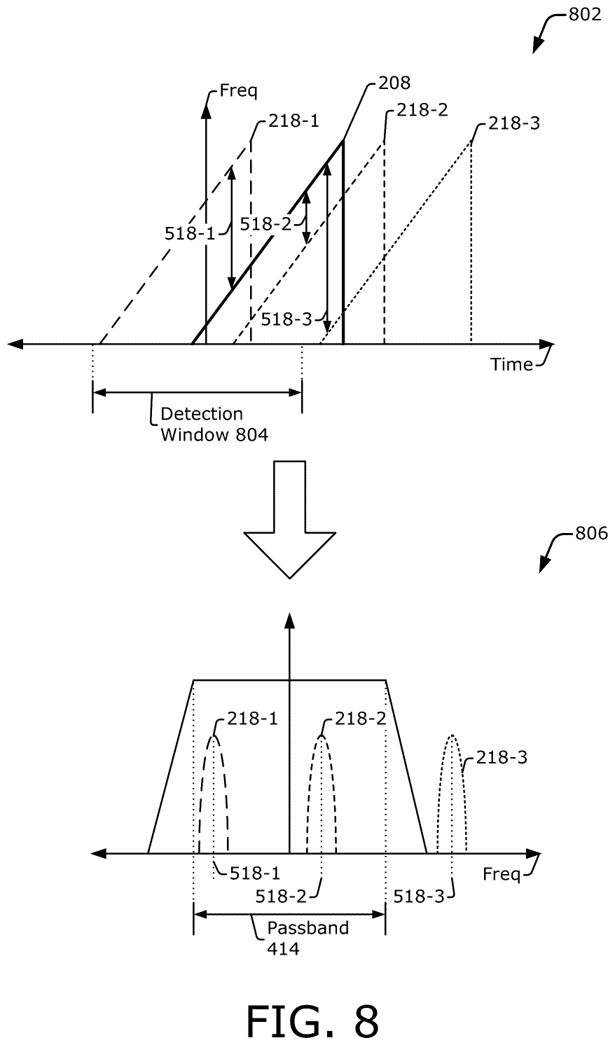

The digital circuit 406, the intermediate-frequency circuit 408, and the radio-frequency circuit 410 can include mixers, filters, or amplifiers to enable the wireless transceiver 120 to perform proximity detection 126 and/or wireless communication 128. In example implementations, the wireless transceiver 120 includes at least one filter 412, which can be integrated within the intermediate-frequency circuit 408 or the digital circuit 406. The filter 412 has a passband 414, which can pass the reflected radar signal 212. Also, the filter 412 can either pass or reject (e.g., attenuate) the radar signal 218 based on the time delay 314, as further described with respect to FIGS. 5 and 8. In an example implementation, the filter 412 is implemented as a low-pass filter.

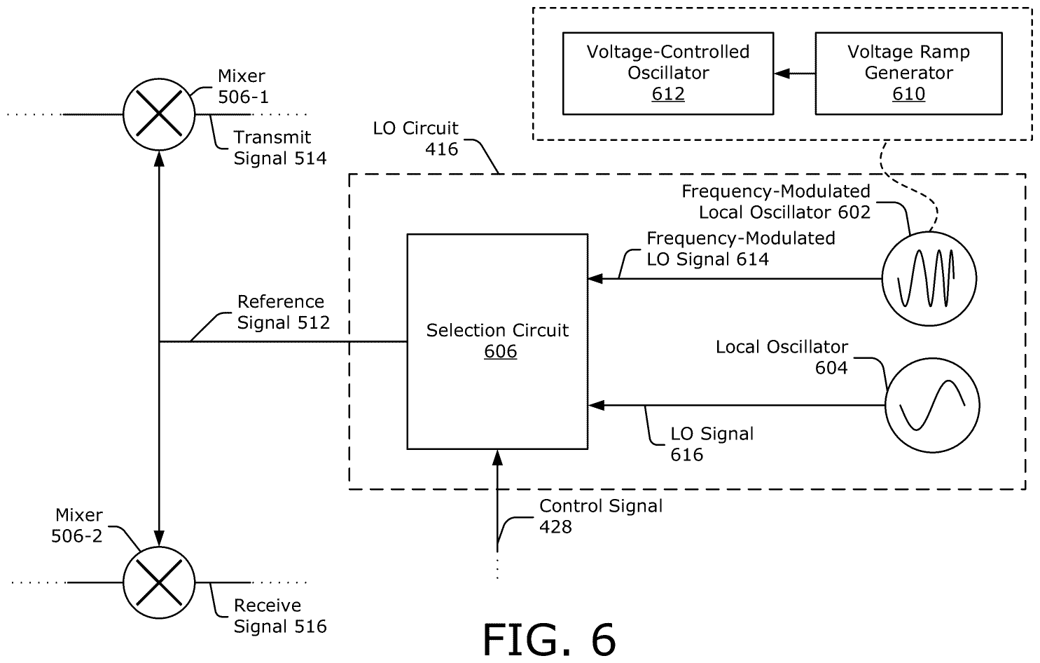

The wireless transceiver 120 also includes at least one local oscillator (LO) circuit 416 (LO circuit 416). In the example implementation shown in FIG. 4, the local oscillator circuit 416 is implemented within the radio-frequency circuit 410. However, other implementations are also possible in which the local oscillator circuit 416 is implemented within the intermediate-frequency circuit or within another part of the wireless transceiver 120. The local oscillator circuit 416 provides a reference signal that enables the wireless transceiver 120 to selectively perform proximity detection 126 or wireless communication 128, as further described with respect to FIGS. 5 and 6. The modem 122 can control a timing of the local oscillator circuit 416 to adjust the time delay 314 associated with transmission of the radar transmit signal 208 during the shareable time slot 310, as further described below.

Along a transmit path, which is shown via the transmitter 402, the digital circuit 406 generates a digital baseband signal 420-1. Based on the digital baseband signal 420-1, the digital circuit 406 generates an analog baseband signal 422-1. The intermediate-frequency circuit 408 upconverts the analog baseband signal 422-1 to produce an intermediate-frequency signal 424-1 (IF signal 424-1). The radio-frequency circuit 410 upconverts the intermediate-frequency signal 424-1 to generate a radio-frequency signal 426-1 (RF signal 426-1). The radio-frequency signal 426-1 is transmitted via at least one of the antennas 124. Depending on the situation or operational mode, the radio-frequency signal 426-1 may represent the uplink signal 202 or the radar transmit signal 208. As shown via the transmit path, the radio-frequency signal 426-1 is derived from the intermediate-frequency signal 424-1, which in turn is derived from the analog baseband signal 422-1 and the digital baseband signal 420-1.

Along the receive path, which is shown via the receiver 404, the radio-frequency circuit 410 accepts another radio-frequency signal 426-2 (RF signal 426-2). The radio-frequency signal 426-2 may represent the downlink signal 204 or the receive signal 210. The radio-frequency circuit 410 downconverts the radio-frequency signal 426-2 to generate an intermediate-frequency signal 424-2 (IF signal 424-2). The intermediate-frequency circuit 408 downconverts the intermediate-frequency signal 424-2 to generate the analog baseband signal 422-2. The digital circuit 406 digitizes the analog baseband signal 422-2 to generate the digital baseband signal 420-2. As shown via the receive path, the digital baseband signal 420-2 is derived from the analog baseband signal 422-2, which in turn is derived from the intermediate-frequency signal 424-2 and the radio-frequency signal 426-2. The digital circuit 406 is illustrated separate from the IF circuit 408, but may be included therein.

During proximity detection 126, the modem 122 can analyze the digital baseband signal 420-2 to detect the object 206. The digital baseband signal 420-2 can contain at least one beat frequency associated with the receive signal 210 and the radar transmit signal 208 of FIG. 2. The beat frequency is further described with respect to FIG. 5. As shown via the multiple upconversion and downconversion stages of the wireless transceiver 120, the wireless transceiver 120 of FIG. 4 implements a superheterodyne transceiver. Alternatively, the wireless transceiver 120 may be implemented as a direct conversion transceiver, which may not include the intermediate-frequency circuit 408.

The modem 122 is operatively coupled to the local oscillator circuit 416 and generates a control signal 428, which the wireless transceiver 120 passes to the local oscillator circuit 416. The control signal 428 controls aspects of the local oscillator circuit 416, including a timing associated with generating a reference signal for proximity detection 126 and an operational mode of the local oscillator circuit 416, as further described with respect to FIG. 5.

FIG. 5 illustrates example components of the transmitter 402, the receiver 404, and the modem 122. In the depicted configuration, the transmitter 402 is coupled between the modem 122 and the antenna array 214. The transmitter 402 is shown to include at least one signal generator 502, at least one digital-to-analog converter (DAC) 504, at least one mixer 506-1, and at least one amplifier 508-1 (e.g., a power amplifier). The signal generator 502 can generate a digital signal (e.g., the digital baseband signal 420-1), which may be used to derive the radar transmit signal 208 or the uplink signal 202. The signal generator 502 (or a portion thereof) may be implemented in the modem 122 and/or the digital circuit 406. The transmitter 402 is connected to at least one feed port of the antenna 124-1. In some examples, the radar transmit signal 208 is generated directly in the RF circuit 410 without use of the digital baseband signal 420-1 or the signal generator 502.

The receiver 404 is coupled between the modem 122 and the antenna array 214. In general, the receiver 404 includes at least one channel, which is coupled to a feed port of the antenna 124-2. In some implementations, the receiver 404 includes multiple channels, which can be coupled to different feed ports of the antenna 124-2 or different feed ports of multiple antennas 124 within the antenna array 214. The receiver 404 includes at least one amplifier 508-2 (e.g., a low-noise amplifier), at least one mixer 506-2, at least one filter 412, and at least one analog-to-digital converter (ADC) 510.

The digital-to-analog converter 504 and/or the analog-to-digital converter 510 may be implemented in the digital circuit 406 or the modem 122. The mixers 506-1 and 506-2 can be implemented in the intermediate-frequency circuit 408 or the radio-frequency circuit 410. The amplifiers 508-1 and 508-2 can be implemented in the radio-frequency circuit 410.

The wireless transceiver 120 also includes the local oscillator circuit 416, which generates a reference signal 512. The reference signal 512 enables the mixers 506-1 and 506-2 to upconvert or downconvert analog signals within the transmitter 402 and the receiver 404. The reference signal 512 can have a continuous tone or can be modulated in frequency, as further described with respect to FIG. 6. During operation, the local oscillator circuit 416 provides an appropriate version of the reference signal 512 to support proximity detection 126 or wireless communication 128. The transmitter 402 and the receiver 404 can also include other additional components that are not depicted in FIG. 5 such as phase shifters, additional amplifiers, additional mixers, switches, and so forth.

During wireless communication 128, the wireless transceiver 120 can transmit the uplink signal 202 or receive the downlink signal 204 (of FIGS. 2 and 3). In particular, the signal generator 502 generates the transmit signal 514, which includes communication data. The digital-to-analog converter 504 converts the transmit signal 514 from the digital domain to the analog domain. The local oscillator circuit 416 generates the reference signal 512 having a continuous tone. The mixer 506-1 upconverts the transmit signal 514 to radio frequencies using the reference signal 512. The amplifier 508-1 amplifies the transmit signal 514, and the antenna 124-1 transmits the transmit signal 514 as the uplink signal 202.

During wireless communication 128, the antenna 124-2 can receive the downlink signal 204. At least one of the receive channels within the receiver 404 processes the downlink signal 204. For example, the amplifier 508-2 amplifies the downlink signal 204, and the mixer 506-2 downconverts the downlink signal 204 using the reference signal 512, which has the continuous tone. The analog-to-digital converter 510 converts the downlink signal 204 from the analog domain to the digital domain. The digital version of the downlink signal 204 can be passed to the modem 122.

During proximity detection 126, the transmitter 402 transmits the radar transmit signal 208 via the antenna 124-1. In particular, the signal generator 502 can generate the transmit signal 514, which can include a single continuous tone. The digital-to-analog converter 504 converts the transmit signal 514 from the digital domain to the analog domain. The local oscillator circuit 416 generates the reference signal 512, which is modulated in frequency. The mixer 506-1 upconverts and modulates the transmit signal 514 using the reference signal 512. The amplifier 508-1 amplifies the transmit signal 514, and the antenna 124-1 transmits the transmits signal 514 as the radar transmit signal 208.

The receiver 404 receives the receive signal 210 via the antenna 124-2. At least one of the receive channels within the receiver 404 processes the receive signal 210. For example, the amplifier 508-2 amplifies the receive signal 210, and the mixer 506-2 downconverts and demodulates the receive signal 210 using the reference signal 512 to produce receive signal 516. The analog-to-digital converter 510 converts the receive signal 516 from the analog domain to the digital domain. The digital version of the receive signal 516 can be passed to the modem 122.

The receive signal 516 includes at least one beat frequency 518, which is indicative of a frequency offset between the radar transmit signal 208 and the receive signal 210. More specifically, the receive signal 210 can sometimes include a first beat frequency 518 associated with the reflected radar signal 212 and/or a second beat frequency associated with the radar signal 218. The first beat frequency 518 represents a frequency offset between the radar transmit signal 208 and the reflected radar signal 212. This frequency offset can be proportional to a distance between the object 206 and the computing device 102.

The second beat frequency 518 represents a frequency offset between the radar transmit signal 208 and the radar signal 218. This frequency offset can be based, at least in part, on a start time of the radar transmit signal 208, a start time of the radar signal 218, and a distance between the device 216 and the computing device 102.

In some cases, the filter 412 can attenuate the second beat frequency 518 and thereby discard the radar signal 218 to prevent a false detection. In this manner, the second beat frequency 518 is not used to determine if an object 206 is present. The filter 412 can also pass the first beat frequency 518. As such, the computing device 102 can detect the object 206 and appropriately adjust a transmission parameter based on the reflected radar signal 212. By filtering the radar signal 218, the computing device 102 can avoid adjusting a transmission parameter based on the radar signal 218 that is received from another device 216.

In FIG. 5, the modem 122 includes at least one proximity detection module 520 and at least one transmitter control module 522 (TX control module 522). The proximity detection module 520 obtains a digital version of the receive signal 516 and generates detection data 524, which indicates whether or not a potential object is detected. The term “potential object” is used to indicate that some implementations of the modem 122 may not be able to distinguish between detecting the object 206 (e.g., an object-of-interest) based on the reflected radar signal 212 and generating a false detection based on the radar signal 218. The detection data 524 can optionally include a range to the object 206.

Based on the detection data 524, the transmitter control module 522 generates at least one transmission parameter 526 that controls one or more transmission attributes for wireless communication 128. The transmission parameter 526 can specify one or more transmission-related aspects of the uplink signal 202, such as a power level, polarization, frequency, duration, beam shape, beam steering angle, a selected antenna that transmits the uplink signal 202 (e.g., another antenna that is on a different surface of the computing device 102 and is not obstructed by the object 206), or combinations thereof. Some transmission parameters 526 may be associated with beam management, such as those that define an unobstructed volume of space for beam sweeping. By specifying the transmission parameter 526, the modem 122 can, for example, cause the transmitter 402 to decrease power if an object 206 is close to the computing device 102 or increase power if the object 206 is at a farther range or is not detectable. The ability to detect the object 206 and control the transmitter 402 enables the modem 122 to balance the performance of the computing device 102 with regulatory compliance guidelines. In other implementations, the application processor 108 or another component (e.g., a sensors hub) can perform one or more of these functions and include the proximity detection module 520.

Additionally or alternatively, the transmitter control module 522 can generate the control signal 428, which controls a timing of the transmission of radar transmit signals 208 within the shareable time slot 310 and/or an operational mode of the wireless transceiver 120. With the control signal 428, the transmitter control module 522 can adjust a time delay 314 for a subsequent shareable time slot 310 if the detection data 524 indicates that a potential object is present. However, if the detection data 524 indicates that a potential object is not present (e.g., a potential object is determined to not be present or within a detectable range), the transmitter control module 522 can maintain a current time delay 314 for a subsequent radar transmit signal 208. This scheme is further described with respect to FIG. 9. Components of the local oscillator circuit 416 that enable the wireless transceiver 120 to selectively perform proximity detection 126 and wireless communication 128 are further described with respect to FIG. 6.

FIG. 6 illustrates an example local oscillator circuit 416 for supporting proximity detection 126 and wireless communication 128. In the depicted configuration, the local oscillator circuit 416 includes a frequency-modulated local oscillator 602, a local oscillator 604, and a selection circuit 606. The frequency-modulated local oscillator 602 can be implemented using a voltage ramp generator 610 and a voltage-controlled oscillator 612. As an example, the voltage-controlled oscillator 612 can be implemented using a wideband open-loop voltage-controlled oscillator. By controlling an input voltage to the voltage-controlled oscillator 612, the voltage ramp generator 610 can provide a variety of different voltage ramps to enable the voltage-controlled oscillator 612 to generate a variety of different frequency-modulated local oscillator signals 614 (e.g., a linear-frequency modulated (LFM) signal, a sawtooth-frequency modulated signal, a triangular-frequency modulated signal, and so forth).

The local oscillator 604 can include, for example, a quartz crystal, an inductor-capacitor (LC) oscillator, an oscillator transistor (e.g., a metal-oxide semiconductor field-effective transistor (MOSFET)), a transmission line, a diode, a piezoelectric oscillator, and so forth. A configuration of the local oscillator 604 can enable a target phase noise and quality factor to be achieved for wireless communication 128. In general, the local oscillator 604 generates a local oscillator signal 616 (LO signal 616) with a steady (e.g., constant) frequency. Although not explicitly shown, the local oscillator circuit 416 can also include a phase lock loop or automatic gain control circuit. Either of these components can be coupled to the local oscillator 604 to enable the local oscillator 604 to oscillate at a (e.g., selectable) steady frequency.

The selection circuit 606 can include a switch or a multiplexer that is controlled by the modem 122. Based on the control signal 428, the selection circuit 606 connects or disconnects the frequency-modulated local oscillator 602 or the local oscillator 604 to or from the mixers 506-1 and 506-2. If the control signal 428 is indicative of the wireless transceiver 120 performing proximity detection 126, the selection circuit 606 connects the frequency-modulated local oscillator 602 to the mixers 506-1 and 506-2 to provide the frequency-modulated local oscillator signal 614 as the reference signal 512. Alternatively, if the control signal 428 is indicative of the wireless transceiver 120 performing wireless communication 128, the selection circuit 606 connects the local oscillator 604 to the mixers 506-1 and 506-2 to provide the local oscillator signal 616 as the reference signal 512. The selection circuit 606 enables the wireless transceiver 120 to quickly transition between performing operations for proximity detection 126 or wireless communication 128.

Although the frequency-modulated local oscillator 602 and the selection circuit 606 are shown in FIG. 6, other implementations of the local oscillator circuit 416 may not include these components. In this case, the local oscillator 604 can provide the local oscillator signal 616 as the reference signal 512 for both proximity detection 126 and wireless communication 128. In this case, the signal generator 502 can apply a frequency modulation to the transmit signal 514 to enable proximity detection 126. In other examples, respective LO circuitry for wireless communication 128 and proximity detection 126 are implemented, and respective reference signals 512 are provided to mixers 506 shared for wireless communication 128 and proximity detection 126 or to respective mixers. The computing device 102 can perform proximity detection 126 within a shareable time slot 310, which is further described with respect to FIG. 7.

FIG. 7 illustrates an example shareable time slot 310. In some cases, the shareable time slot 310 can selectively be used for proximity detection 126 and/or wireless communication 128. An example shareable time slot 310 includes an uplink random-access-channel (RACH) time slot 702 (UL RACH time slot 702). For proximity detection 126, a duration of the shareable time slot 310 can be represented by three different timing windows, which include a first transition window 704, a second transition window 706, and an available window 708. Durations of the windows 704, 706, and 708 are not necessarily drawn to scale in FIG. 7.

The first transition window 704 represents a time interval for configuring the wireless transceiver 120 for proximity detection 126. In some implementations, this time interval enables tuning of the local oscillator circuit 416 for proximity detection 126. A duration of the first transition window 704 can be based, at least in part, on a settling time associated with a phase lock loop of the local oscillator circuit 416. In general, the duration of the first transition window 704 is sufficient to enable the wireless transceiver 120 to transition from the wireless communication mode 300-1 to the proximity detection mode 300-2 during a beginning portion of the shareable time slot 310.

The second transition window 706 represents a time interval for configuring the wireless transceiver 120 for wireless communication 128. In some implementations, this time interval enables tuning of the local oscillator circuit 416 for wireless communication 128. A duration of the second transition window 706 can be based, at least in part, on the settling time associated with the phase lock loop of the local oscillator circuit 416. In general, a duration of the second transition window 706 is sufficient to enable the wireless transceiver 120 to transition from the proximity detection mode 300-2 to the wireless communication mode 300-1 during a last portion of the shareable time slot 310.

The available window 708 represents a time interval for transmitting the radar transmit signal 208 and receiving the receive signal 210 for proximity detection 126. Within the available window 708, the radar transmit signal 208 is transmitted with a duration 710 (radar transmission duration 710). The radar transmission duration 710 is less than a duration of the available window 708. In an example implementation, the duration 710 is approximately equal to a fourth of the duration of the shareable time slot 310. In some cases, the duration 710 represents a particular quantity of symbols, such as 2, 3, or 4 symbols.

The time delay 314 represents a difference between a start time 712 of the radar transmission and a start time of the shareable time slot 310. The time delay 314 can be selectively or randomly chosen from a set (e.g., a list) of multiple time delays. The time delays 314 within the set can vary by a particular interval, which can be proportional to the bandwidth of the filter 412. In general, the time delay 314 enables the radar transmit signal 208 to be transmitted and the receive signal 210 to be received within the available window 708. In some circumstances, the available window 708 includes additional free time between an end of the radar transmission and the beginning of the transition window 706, as shown at 714. The time delay 314 can be adjusted to mitigate radar-to-radar jamming, as further described with respect to FIG. 8.

FIG. 8 illustrates radar-to-radar jamming within a shareable time slot 310. A graph 802 depicts times during which a radar transmit signal 208 is transmitted and radar signals 218-1, 218-2, and/or 218-3 are received as part of a receive signal 210. These times can occur during the available window 708 of the shareable time slot 310, which is shown in FIG. 7. Differences between frequencies of the radar transmit signal 208 and the radar signals 218-1, 218-2, and 218-3 are represented by beat frequencies 518-1, 518-2, and 518-3, respectively.

At least a portion of the radar signals 218-1 and 218-2 are received during a detection window 804. The radar signal 218-3, however, is received outside of the detection window 804. A center of the detection window 804 can be aligned to a start time of the radar transmit signal 208. In general, a duration of the detection window 804 is proportional to the bandwidth of the filter 412. Portions of the radar signals 218 that are received during the detection window 804 can cause the modem 122 to generate false detections.

A graph 806 illustrates a frequency response of the filter 412, which includes the passband 414. The wireless transceiver 120 generates the receive signal 516 having the beat frequencies 518-1, 518-2, and/or 518-3. The beat frequencies 518-1 and 518-2 are within the passband 414 of the filter 412. The beat frequency 518-3, however, is outside the passband 414 of the filter 412. In this case, the beat frequencies 518-1 and 518-2 can pass through the filter 412 and can be processed by the modem 122. The beat frequency 518-3, however, is substantially attenuated by the filter 412. Due to this attenuation, the modem 122 is unlikely to detect a potential object based on the beat frequency 518-3. The modem 122, however, may detect a potential object (e.g., generate false detections) based on the beat frequencies 518-1 and 518-2. To mitigate radar-to-radar jamming, the modem 122 can adjust the timing delay 314 to cause one or more of the beat frequencies 518-1 and/or 518-2 to be positioned outside of the passband 414 of the filter 412 along with the beat frequency 518-3. This adjustment is further described with respect to FIG. 9.

FIG. 9 illustrates an example scheme for mitigating radar-to-radar jamming within the shareable time slot 310. The computing device 102 selectively performs proximity detection 126 and wireless communication 128 over different time intervals. For example, the computing device 102 performs proximity detection 126 during shareable time slots 310-1, 310-2, 310-3, and 310-4. Also, the computing device 102 can optionally perform wireless communication 128 during other time intervals that exist before, between, and/or after the shareable time slots 310-1 to 310-4, as indicated by the shaded fill pattern in FIG. 9. In some cases, a duration between shareable time slots 310 can be less than the duration 710 of the radar transmit signal 208.

During the first shareable time slot 310-1, the computing device 102 transmits a first radar transmit signal 208-1 having a first time delay 314-1 (TD 314-1). The computing device 102 also receives a first receive signal 210-1. In this case, the first receive signal 210-1 is modulated in frequency. More specifically, the receive signal 210-1 can include the reflected radar signal 212, the radar signal 218 transmitted by another device 216, or a combination thereof. Based on the first receive signal 210-1, the computing device 102 detects a potential object, which can be the object 206 or a false detection. In particular, the potential object can be an object-of-interest (e.g., a portion of the user) that is based on the reflected radar signal 212 or a false detection based on the radar signal 218. Because the computing device 102 detected the potential object, the modem 122 adjusts the time delay 314 for a subsequent shareable time slot (e.g., for the shareable time slot 310-2). In some implementations, the modem 122 selects the subsequent time delay 314 from a set of multiple time delays. The set of multiple time delays may or may not include the first time delay 314-1. This selection may be based on one or more rules, or may be random.

During the second shareable time slot 310-2, the computing device 102 transmits a second radar transmit signal 208-2 having a second time delay 314-2 (TD 314-2). The second time delay 314-2 is different than the first time delay 314-1. In some cases, the second time delay 314-2 is sufficiently different than the first time delay 314-1 to cause the radar signal 218 (if detected during the first shareable time slot 310-1) to be positioned outside of the passband 414 of the filter 412 during the second shareable time slot 310-2. In example implementations, a difference between the second time delay 314-2 and the first time delay 314-2 is proportional to the bandwidth of the filter 412.

The computing device 102 receives the receive signal 210-2 during the second shareable time slot 310-2. The receive signal 210-2 includes noise and does not include the reflected radar signal 212 or a radar signal 218. In this case, the computing device 102 determines that a potential object is not present. Consequently, the computing device 102 can maintain (e.g., need not adjust) the time delay 314-2 for a subsequent shareable time slot (e.g., for the shareable time slot 310-3). In this case, the time delay 314-3 associated with the shareable time slot 310-3 is approximately equal to the time delay 314-2.

This scheme can continue for subsequent shareable time slots 310. In general, the modem 122 adjusts the time delay 314 for subsequent shareable time slots 310 based on a potential object being detected in a previous shareable time slot 310. Also, if the modem 122 determines that a potential object is absent (or not present) for a current shareable time slot 310, the modem 122 maintains a current time delay 314 for subsequent shareable time slots 310, at least until a potential object is detected later. By avoiding adjusting the time delay 314 during periods in which the modem 122 determines that a potential object is not present, the modem 122 can reduce a probability of unintentionally selecting a time delay 314 that causes radar-to-radar jamming. Thus, the time delay 314 can be selectively adjusted, for example based on whether a potential object is detected. Further, the time delay 314 may be adjusted every time a potential object is detected in some examples. Thus, the time delay 314 may continually shift when an actual object is present, but may settle on a value which avoids an interfering radar when no detectable object is present.

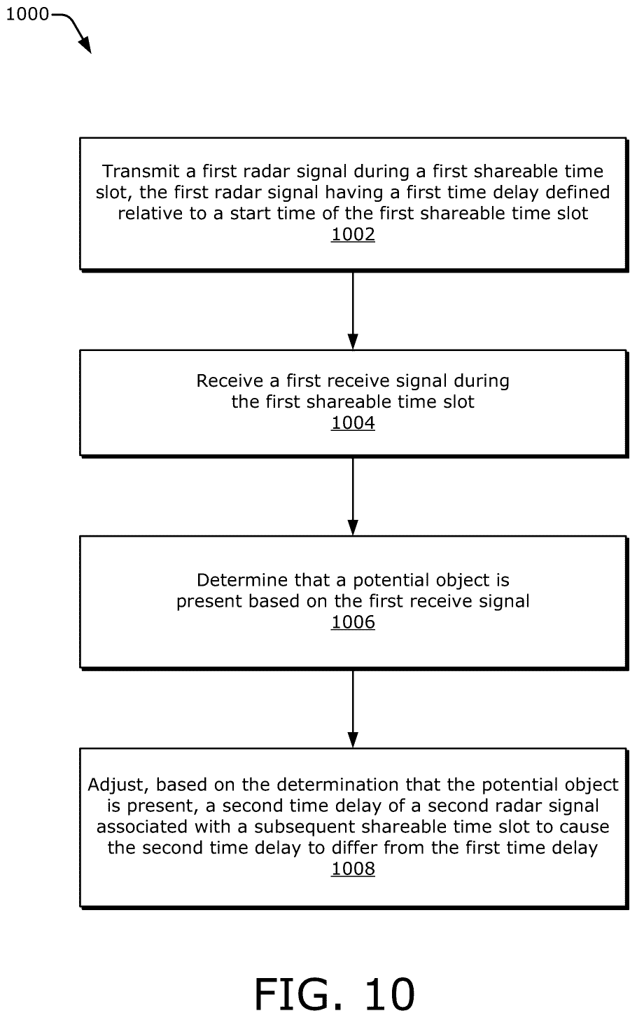

FIG. 10 is a flow diagram illustrating an example process 1000 for mitigating radar-to-radar jamming within a shareable time slot. The process 1000 is described in the form of a set of blocks 1002-1008 that specify operations that can be performed. However, operations are not necessarily limited to the order shown in FIG. 10 or described herein, for the operations may be implemented in alternative orders or in fully or partially overlapping manners. Operations represented by the illustrated blocks of the process 1000 may be performed by a computing device 102 (e.g., of FIG. 1 or 2). More specifically, the operations of the process 1000 may be performed at least partially by a wireless transceiver 120 (e.g., of FIG. 1, 4, or 5) and at least partially by a modem 122 (e.g., of FIG. 1, 4, or 5).

At block 1002, a first radar signal is transmitted during a first shareable time slot. The first radar signal has a first time delay defined relative to a start time of the first shareable time slot. For example, the wireless transceiver 120 transmits a first radar transmit signal 208 (e.g., radar transmit signal 208-1) during a first shareable time slot 310 (e.g., shareable time slot 310-1), as shown in FIGS. 3 and 9. The first shareable time slot 310 can be associated with wireless communication and represent an uplink random-access-channel time slot 702, as shown in FIG. 7. In general, the first shareable time slot 310 represents a time slot in which at least two devices (e.g., the computing device 102 and the other computing device 216) transmit radar signals 208 and 218.

At block 1004, a first receive signal is received during the first shareable time slot. For example, the wireless transceiver 120 receives a first receive signal 210 during the first shareable time slot 310. The first receive signal 210 can include the reflected radar signal 212, a radar signal 218 transmitted by another device 216, both signals 212 and 218, or neither signal 212 nor 218 (e.g., noise).

At block 1006, a determination is made that a potential object is present based on the first receive signal. For example, the modem 122 determines that a potential object is present based on the first receive signal 210, as described with respect to FIG. 5.

At block 1008, a second time delay of a second radar signal associated with a subsequent shareable time slot is adjusted based on the determination that the potential object is present. The adjusting causes the second time delay to differ from the first time delay. For example, the modem 122 adjusts the time delay 314 (e.g., the time delay 314-2) of the second radar transmit signal 208 associated with a subsequent shareable time slot (e.g., the shareable time slot 310-2) based on the determination that the potential object is present. Adjusting may include or consist of setting the second time delay to a different value than the first time delay or selecting such second time delay. Thus, the adjusting causes the second time delay 314 (e.g., the time delay 314-2) to differ from the first time delay 314 (e.g., the time delay 314-1). The first shareable time slot and the second shareable time slot can be consecutive shareable time slots (e.g., the subsequent shareable time slot represents a next shareable time slot that occurs after the at least one shareable time slot).

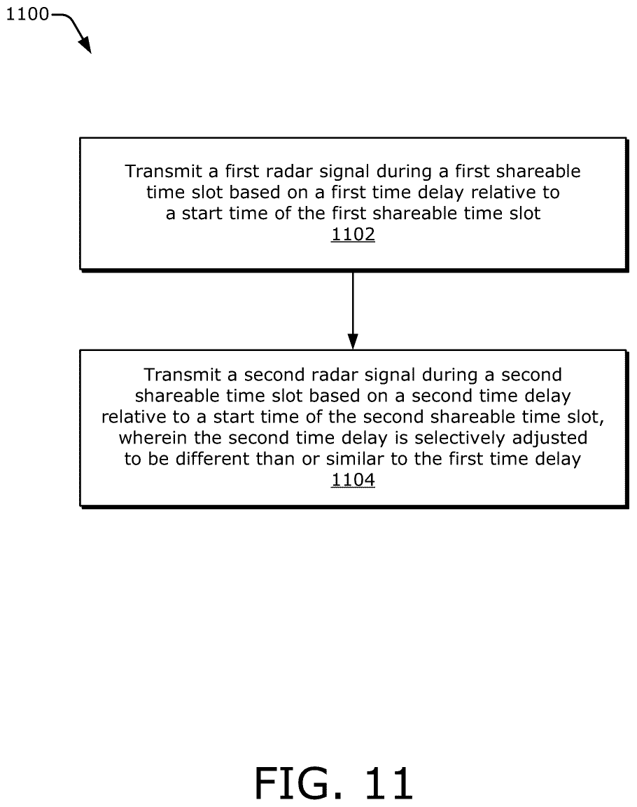

FIG. 11 is another flow diagram illustrating an example process 1100 for mitigating radar-to-radar jamming within a shareable time slot. The process 1100 is described in the form of a set of blocks 1102 and 1104 that specify operations that can be performed. However, operations are not necessarily limited to the order shown in FIG. 11 or described herein, for the operations may be implemented in alternative orders or in fully or partially overlapping manners. Operations represented by the illustrated blocks of the process 1100 may be performed by a computing device 102 (e.g., of FIG. 1 or 2). More specifically, the operations of the process 1100 may be performed at least partially by a wireless transceiver 120 (e.g., of FIG. 1, 4, or 5).

At block 1102, a first radar signal is transmitted during a first shareable time slot based on a first time delay relative to a start time of the first shareable time slot. For example, the wireless transceiver 120 transmits the first radar signal 208-1 during a first shareable time slot 310-1 based on a first time delay 314-1 relative to a start time of the first shareable time slot 310-1.

At block 1104, a second radar signal is transmitted during a second shareable time slot based on a second time delay relative to a start time of the second shareable time slot. The second time delay is selectively adjusted to be different than or similar to the first time delay. For example, the wireless transceiver 120 transmits the second radar signal 208-2 during a second shareable time slot 310-2 based on a second time delay 314-2 relative to a start time of the second shareable time slot 310-2. The second shareable time slots 310-2 can be a next shareable time slot 310 that occurs after the first shareable time slot 310-1. The modem 122 can selectively adjust the second time delay 314-2 to be different than or similar to the first time delay 314-1.

For example, if the modem 122 detects a potential object after transmitting the first radar signal 208-1, the modem 122 can adjust the second time delay 314-2 to be different than the first time delay 314-1. In general, the second time delay 314-2 is sufficiently different than the first time delay 314-1 to cause a radar signal 218 transmitted by another computing device 216 during the first shareable time slot 310-1 to be attenuated by the filter 412 (e.g., to be outside the passband 414 of the filter 412) during the second shareable time slot 310-2. A difference between the second time delay 314-2 and the first time delay 314-1 can be proportional to the bandwidth of the filter 412.

Otherwise, if the modem 122 does not detect a potential object after transmitting the first radar signal 208-1, the modem 122 can set the second time delay 314-2 to be similar to the first time delay 314-2. For instance, the second time delay 314-2 can be equal to the first time delay 314-1. Other values of the second time delay 314-2 are also possible such that the second time delay 314-2 is approximately equal to the first time delay 314-1 (e.g., a difference between the second time delay 314-2 and the first time delay 314-1 is less than a time interval associated with the bandwidth of the filter 412).

Some aspects are described below.

Aspect 1: An apparatus comprising:
a wireless transceiver configured to:
   be coupled to at least two antennas;
   transmit, using a first antenna of the at least two antennas, a first radar signal during a first shareable time slot, the first radar signal having a start time that is delayed relative to a start time of the first shareable time slot by a first time delay;
   receive, using a second antenna of the at least two antennas, a first receive signal during the first shareable time slot;
   detect a potential object based on the first receive signal; and
   transmit, using the first antenna, a second radar signal during a second shareable time slot, the second radar signal having a start time that is delayed relative to a start time of the second shareable time slot by a second time delay, the second time delay being different than the first time delay based on the detection of the potential object.

Aspect 2: The apparatus of aspect 1, wherein at least a portion of the first and second shareable time slots represent a time interval in which proximity detection can be performed by the apparatus and at least one other apparatus.

Aspect 3: The apparatus of aspect 1 or 2, wherein the first and second shareable time slots comprise uplink random-access-channel time slots.

Aspect 4: The apparatus of aspect 1, wherein:
the first receive signal comprises a version of the first radar signal that is reflected by an object; and
the potential object represents the object.

Aspect 5: The apparatus of aspect 1, wherein:
the first receive signal comprises another radar signal transmitted by another apparatus; and
the potential object represents a false detection.

Aspect 6: The apparatus of aspect 1, wherein the first radar signal, the first receive signal, and the second radar signal comprise frequency-modulated continuous-wave radar signals.

Aspect 7: The apparatus of any previous aspect, wherein the second time delay represents a time delay selected randomly from a set of multiple time delays.

Aspect 8: The apparatus of any previous aspect, wherein the wireless transceiver is configured to:
receive, using the second antenna, a second receive signal during the second shareable time slot;
determine an absence of the potential object based on the second receive signal; and
transmit, using the first antenna, a third radar signal during a third shareable time slot, the third radar signal having a start time that is delayed relative to a start time of the third shareable time slot by a third time delay, the third time delay being approximately equal to the second time delay based on a determination that the potential object is absent.

Aspect 9: The apparatus of aspect 8, wherein the wireless transceiver is configured to:
receive, using the second antenna, a third receive signal during the third shareable time slot;
detect an additional potential object based on the third receive signal; and
transmit, using the first antenna, a fourth radar signal during a fourth shareable time slot, the fourth radar signal having a start time that is delayed relative to a start time of the fourth shareable time slot by a fourth time delay, the fourth time delay being different than the first time delay and the second time delay based on the detection of the additional potential object.

Aspect 10: The apparatus of any previous aspect, wherein:
the wireless transceiver is configured to receive, using the second antenna, a second receive signal during the second shareable time slot;
the first and second receive signals each comprise a radar signal that is transmitted by another apparatus;
the radar signal associated with the first receive signal has a beat frequency that is within a passband of a filter of the wireless transceiver based on the first time delay; and
the radar signal associated with the second receive signal has another beat frequency that is outside of the passband of the filter based on the second time delay.

Aspect 11: The apparatus of aspect 10, wherein the filter comprises a low-pass filter.

Aspect 12: The apparatus of any previous aspect, wherein:
the wireless transceiver comprises a local oscillator circuit having a tuning time;
the wireless transceiver is configured to generate the first radar signal and the second radar signal using the local oscillator circuit; and
the first and second time delays are greater or equal to a tuning time associated with the local oscillator circuit.

Aspect 13: The apparatus of any previous aspect, wherein the wireless transceiver is configured to:
adjust a transmission parameter based on the detection of the potential object; and
transmit, using at least one of the at least two antennas, an uplink signal using the transmission parameter.

Aspect 14: The apparatus of aspect 13, wherein the transmission parameter comprises at least one of the following:
a power level;
a beam steering angle;
a frequency;
a selected antenna: or
a communication protocol.

Aspect 15: A method comprising:
transmitting a first radar signal during a first shareable time slot, the first radar signal having a first time delay defined relative to a start time of the first shareable time slot;
receiving a first receive signal during the first shareable time slot;
determining that a potential object is present based on the first receive signal; and
adjusting, based on the determination that the potential object is present, a second time delay of a second radar signal associated with a subsequent shareable time slot to cause the second time delay to differ from the first time delay.

Aspect 16: The method of aspect 15, wherein:
the first receive signal comprises at least one of the following:
   a version of the first radar signal that is reflected by an object; or
   another radar signal; and
the potential object represents at least one of the following:
   the object based on the first receive signal comprising the version of the first radar signal that is reflected by the object: or
a false detection based on the first receive signal comprising the other radar signal.

Aspect 17: The method of aspect 15 or 16, further comprising:
transmitting a third radar signal during a third shareable time slot, the third radar signal having a third time delay;
receiving a third receive signal during the third shareable time slot;
determining that the potential object is not present based on the third receive signal; and
setting, based on the determination that the potential object is not present, another time delay associated with another subsequent shareable time slot to cause the other time delay to be equal to the third time delay.

Aspect 18: The method of any one of aspects 15 to Error! Reference source not found.17, wherein the first shareable time slot and the subsequent shareable time slot are associated with wireless communication.

Aspect 19: The method of any one of aspects 15 to Error! Reference source not found.18, wherein the first shareable time slot and the subsequent shareable time slot comprise uplink random-access-channel time slots.

Aspect 20: The method of any one of aspects 15 to 18, wherein the adjusting of the second time delay comprises selecting the second time delay from a set of multiple time delays.

Aspect 21: The method of aspect 20, wherein the selecting of the second time delay comprises randomly selecting the second time delay from the set of multiple time delays.

Aspect 22: An apparatus comprising:
means for transmitting multiple radar signals during multiple shareable time slots, the multiple radar signals having respective time delays defined relative to start times of the multiple shareable time slots;
means for receiving multiple receive signals during the multiple shareable time slots;
means for determining, for at least one shareable time slot of the multiple shareable time slots, that a potential object is present based on a corresponding receive signal of the multiple receive signals; and
means for adjusting, based on the determination for the at least one shareable time slot that the potential object is present, a time delay of a radar signal associated with a subsequent shareable time slot to cause the time delay to differ from a time delay associated with the at least one shareable time slot.

Aspect 23: The apparatus of aspect 22, further comprising:
means for determining, for at least one other shareable time slot of the multiple shareable time slots, that the potential object is not present based on a corresponding receive signal of the multiple receive signals; and
means for setting, based on the determination for the at least one other shareable time slot that the potential object is not present, another time delay associated with another subsequent shareable time slot to cause the other time delay to be similar to a time delay associated with the at least one other shareable time slot.

Aspect 24: The apparatus of aspect 22 or 23, further comprising:
means for adjusting a transmission parameter based on the determination that the potential object is present; and
means for transmitting an uplink signal using the transmission parameter.

Aspect 25: The apparatus of any one of aspects 22 to 24, wherein the at least one shareable time slot and the subsequent shareable time slot comprise consecutive shareable time slots.

Aspect 26: A method comprising:
transmitting a first radar signal during a first shareable time slot based on a first time delay relative to a start time of the first shareable time slot; and
transmitting a second radar signal during a second shareable time slot based on a second time delay relative to a start time of the second shareable time slot,
wherein the second time delay is selectively adjusted to be different than the first time delay.

Aspect 27: The method of aspect 26, further comprising:
receiving a first receive signal during the first shareable time slot; and
selectively adjusting the second time delay to be different than the first time delay based on the first receive signal indicating a presence of a potential object.

Aspect 28: The method of aspect 27, wherein:
the first receive signal comprises at least one of the following:
   a version of the first radar signal that is reflected by an object: or
   another radar signal; and
the potential object represents at least one of the following:
   the object based on the first receive signal comprising the version of the first radar signal that is reflected by the object: or
   a false detection based on the first receive signal comprising the other radar signal.

Aspect 29: The method of aspect 26, further comprising:
receiving a first receive signal during the first shareable time slot; and
selectively adjusting the second time delay to be equal to the first time delay based on the first receive signal indicating an absence of a potential object.

Aspect 30: The method of any one of aspects 26 to 29, wherein the first shareable time slot and the second shareable time slot comprise uplink random-access-channel time slots.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
a wireless transceiver configured to:
be coupled to at least two antennas;
transmit, using a first antenna of the at least two antennas, a first radar signal during a first shareable time slot, the first radar signal having a start time that is delayed relative to a start time of the first shareable time slot by a first time delay;
receive, using a second antenna of the at least two antennas, a first receive signal during the first shareable time slot;
detect a potential object based on the first receive signal; and
transmit, using the first antenna, a second radar signal during a second shareable time slot, the second radar signal having a start time that is delayed relative to a start time of the second shareable time slot by a second time delay, the second time delay being different than the first time delay based on the detection of the potential object.

2. The apparatus of claim 1, wherein at least a portion of the first and second shareable time slots represent a time interval in which proximity detection can be performed by the apparatus and at least one other apparatus.

3. The apparatus of claim 1, wherein the first and second shareable time slots comprise uplink random-access-channel time slots.

4. The apparatus of claim 1, wherein:
the first receive signal comprises a version of the first radar signal that is reflected by an object; and
the potential object represents the object.

5. The apparatus of claim 1, wherein:
the first receive signal comprises another radar signal transmitted by another apparatus; and
the potential object represents a false detection.

6. The apparatus of claim 1, wherein the first radar signal, the first receive signal, and the second radar signal comprise frequency-modulated continuous-wave radar signals.

7. The apparatus of claim 1, wherein the second time delay represents a time delay selected randomly from a set of multiple time delays.

8. The apparatus of claim 1, wherein the wireless transceiver is configured to:
receive, using the second antenna, a second receive signal during the second shareable time slot;
determine an absence of the potential object based on the second receive signal; and
transmit, using the first antenna, a third radar signal during a third shareable time slot, the third radar signal having a start time that is delayed relative to a start time of the third shareable time slot by a third time delay, the third time delay being approximately equal to the second time delay based on a determination that the potential object is absent.

9. The apparatus of claim 8, wherein the wireless transceiver is configured to:
receive, using the second antenna, a third receive signal during the third shareable time slot;
detect an additional potential object based on the third receive signal; and
transmit, using the first antenna, a fourth radar signal during a fourth shareable time slot, the fourth radar signal having a start time that is delayed relative to a start time of the fourth shareable time slot by a fourth time delay, the fourth time delay being different than the first time delay and the second time delay based on the detection of the additional potential object.

10. The apparatus of claim 1, wherein:
the wireless transceiver is configured to receive, using the second antenna, a second receive signal during the second shareable time slot;
the first and second receive signals each comprise a radar signal that is transmitted by another apparatus;
the radar signal associated with the first receive signal has a beat frequency that is within a passband of a filter of the wireless transceiver based on the first time delay; and
the radar signal associated with the second receive signal has another beat frequency that is outside of the passband of the filter based on the second time delay.

11. The apparatus of claim 10, wherein the filter comprises a low-pass filter.

12. The apparatus of claim 1, wherein:
the wireless transceiver comprises a local oscillator circuit having a tuning time;
the wireless transceiver is configured to generate the first radar signal and the second radar signal using the local oscillator circuit; and
the first and second time delays are greater or equal to a tuning time associated with the local oscillator circuit.

13. The apparatus of claim 1, wherein the wireless transceiver is configured to:
adjust a transmission parameter based on the detection of the potential object; and
transmit, using at least one of the at least two antennas, an uplink signal using the transmission parameter.

14. The apparatus of claim 13, wherein the transmission parameter comprises at least one of the following:
a power level;
a beam steering angle;
a frequency;
a selected antenna: or
a communication protocol.

15. A method comprising:
transmitting a first radar signal during a first shareable time slot, the first radar signal having a first time delay defined relative to a start time of the first shareable time slot;
receiving a first receive signal during the first shareable time slot;
determining that a potential object is present based on the first receive signal; and
adjusting, based on the determination that the potential object is present, a second time delay of a second radar signal associated with a subsequent shareable time slot to cause the second time delay to differ from the first time delay.

16. The method of claim 15, wherein:
the first receive signal comprises at least one of the following:
a version of the first radar signal that is reflected by an object: or
another radar signal; and
the potential object represents at least one of the following:
the object based on the first receive signal comprising the version of the first radar signal that is reflected by the object: or
a false detection based on the first receive signal comprising the other radar signal.

17. The method of claim 15, further comprising:
transmitting a third radar signal during a third shareable time slot, the third radar signal having a third time delay;
receiving a third receive signal during the third shareable time slot;
determining that the potential object is not present based on the third receive signal; and
setting, based on the determination that the potential object is not present, another time delay associated with another subsequent shareable time slot to cause the other time delay to be equal to the third time delay.

18. The method of claim 15, wherein the first shareable time slot and the subsequent shareable time slot are associated with wireless communication.

19. The method of claim 18, wherein the first shareable time slot and the subsequent shareable time slot comprise uplink random-access-channel time slots.

20. The method of claim 15, wherein the adjusting of the second time delay comprises selecting the second time delay from a set of multiple time delays.

21. The method of claim 20, wherein the selecting of the second time delay comprises randomly selecting the second time delay from the set of multiple time delays.

22. An apparatus comprising:
means for transmitting multiple radar signals during multiple shareable time slots, the multiple radar signals having respective time delays defined relative to start times of the multiple shareable time slots;
means for receiving multiple receive signals during the multiple shareable time slots;
means for determining, for at least one shareable time slot of the multiple shareable time slots, that a potential object is present based on a corresponding receive signal of the multiple receive signals; and
means for adjusting, based on the determination for the at least one shareable time slot that the potential object is present, a time delay of a radar signal associated with a subsequent shareable time slot to cause the time delay to differ from a time delay associated with the at least one shareable time slot.

23. The apparatus of claim 22, further comprising:
means for determining, for at least one other shareable time slot of the multiple shareable time slots, that the potential object is not present based on a corresponding receive signal of the multiple receive signals; and
means for setting, based on the determination for the at least one other shareable time slot that the potential object is not present, another time delay associated with another subsequent shareable time slot to cause the other time delay to be similar to a time delay associated with the at least one other shareable time slot.

24. The apparatus of claim 22, further comprising:
means for adjusting a transmission parameter based on the determination that the potential object is present; and
means for transmitting an uplink signal using the transmission parameter.

25. The apparatus of claim 22, wherein the at least one shareable time slot and the subsequent shareable time slot comprise consecutive shareable time slots.

26. A method comprising:
transmitting a first radar signal during a first shareable time slot based on a first time delay relative to a start time of the first shareable time slot; and
transmitting a second radar signal during a second shareable time slot based on a second time delay relative to a start time of the second shareable time slot,
wherein the second time delay is selectively adjusted to be different than or similar to the first time delay.

27. The method of claim 26, further comprising:
receiving a first receive signal during the first shareable time slot; and
selectively adjusting the second time delay to be different than the first time delay based on the first receive signal indicating a presence of a potential object.

28. The method of claim 27, wherein:
the first receive signal comprises at least one of the following:
a version of the first radar signal that is reflected by an object; or
another radar signal; and
the potential object represents at least one of the following:
the object based on the first receive signal comprising the version of the first radar signal that is reflected by the object; or
a false detection based on the first receive signal comprising the other radar signal.

29. The method of claim 26, further comprising:
receiving a first receive signal during the first shareable time slot; and
selectively adjusting the second time delay to be equal to the first time delay based on the first receive signal indicating an absence of a potential object.

30. The method of claim 26, wherein the first shareable time slot and the second shareable time slot comprise uplink random-access-channel time slots.
